(19) United States
(12) Patent Application Publication
(10) Pub. No.: US 2007/0279172 A1
(43) Pub. Date: Dec. 6, 2007

(54) Electric device and method for producing the same

(76) Inventors: Sheng-Nan Huang, Kaohsiung County (TW); Kuei-Yun Lin, Kaohsiung County (TW)

Correspondence Address: CHRISTIE, PARKER & HALE, LLP, PO BOX 7068, PASADENA, CA, 91109-7068, US

(21) Appl. No.: 11/443,924

(22) Filed: May 30, 2006

(51) Int. Cl. H01F 27/02

(52) U.S. Cl. 336/90

(57) ABSTRACT

An electric device includes: a housing; a plurality of conductive leads provided on the housing; at least one coil unit disposed in the housing, electrically connected to the conductive leads, and including a core and an enameled wire wound around the core; and a heat insulator disposed in the housing and covering at least one side of the coil unit. A method for producing an electric device includes the steps of: providing a housing confining an inner space therein and provided with a plurality of conductive leads thereon; disposing at least one coil unit in the inner space of the housing, and electrically connecting the coil unit to the conductive leads, the coil unit having a core and an enamelled wire wound around the core; and mounting a heat insulator in the inner space of the housing for covering one side of the coil unit.

### BACKGROUND OF THE INVENTION

1. Field of the Invention

This invention relates to an electric device and a method for producing the same, more particularly to an electric device having a heat insulator and a method for producing the same.

2. Description of the Related Art

An electric device 1, such as a filter or a transformer, generally has a structure shown in FIG. 1, which includes a casing 11, coil units 12, and a plurality of conductive leads 13 provided on the casing 11. Each of the coil units 12 includes a core 121 and an enamelled wire 122. The conductive leads 13 are electrically connected to the enamelled wires 122 of the coil units 12, respectively.

When the electric device 1 is to be bonded to a printed circuit board, a solder composition has to be used. The electric device 1 applied with the solder composition is heated in a reflow furnace, thereby accomplishing the bonding purpose. At present, the employed solder composition is usually a lead-tin alloy, the melting temperature of which is 210 to 220° C. As a consequence, the reflow furnace is normally operated at a temperature within 210 to 220° C. to melt the solder composition. Although the coating coated on the enamelled wire 122 merely tolerates a temperature of up to 200° C., the coating on the enamelled wire 122 can be protected by the casing 11 from being damaged when the electric device 1 passes through the reflow furnace. That is, the environment temperature around the enamelled wires 122 in the casing 11 is kept below 200° C. during the reflowing process.

However, in 2003, the European Union passed the Restriction of Hazardous Substance (RoHS) Act, which mandates that the following chemicals and compounds be removed from products sold in the European Union effective 2006: lead and lead compounds; hexavalent chromium compounds; cadmium and cadmium compounds; mercury and mercury compounds; flame retardant systems based on polybrominated byphenyls (PBB); and polybrominated diphenyl ethers (PBDE). In order to comply with the provision, a lead-containing solder material has to be replaced with a lead-free solder composition. However, the temperature for melting the commercially available lead-free solder composition in the reflow furnace is around 260 to 270° C., which is too high for the enameled wire 122 even though the casing 11 provides certain heat insulating effect. The electric device 1 is likely to be damaged, and the failure rate thereof will be higher.

Therefore, there is a need in the art to provide an electric device that can tolerate the temperature of the reflow furnace for melting the lead-free solder composition while maintaining the required properties.

### SUMMARY OF THE INVENTION

Therefore, the object of the present invention is to provide an electric device that has superior heat tolerance than the conventional electric device, and to provide a method for producing the same.

According to one aspect of this invention, an electric device includes: a housing; a plurality of conductive leads provided on the housing; at least one coil unit disposed in the housing, electrically connected to the conductive leads, and including a core and an enamelled wire wound around the core; and a heat insulator disposed in the housing and covering at least one side of the coil unit.

According to another aspect of this invention, a method for producing an electric device includes the steps of: providing a housing confining an inner space therein and provided with a plurality of conductive leads thereon; disposing at least one coil unit in the inner space of the housing, and electrically connecting the coil unit to the conductive leads, the coil unit having a core and an enamelled wire wound around the core; and mounting a heat insulator in the inner space of the housing for covering one side of the coil unit.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a schematic sectional view of a conventional electric device;

FIG. 2 is an exploded perspective view of the first preferred embodiment of an electric device according to this invention;

FIG. 3 is a schematic assembled sectional view of the first preferred embodiment;

FIG. 4 is a schematic assembled sectional view of the second preferred embodiment of an electric device according to this invention; and

FIG. 5 is a flow chart illustrating consecutive steps of the preferred embodiment of a method for producing an electric device according to this invention.

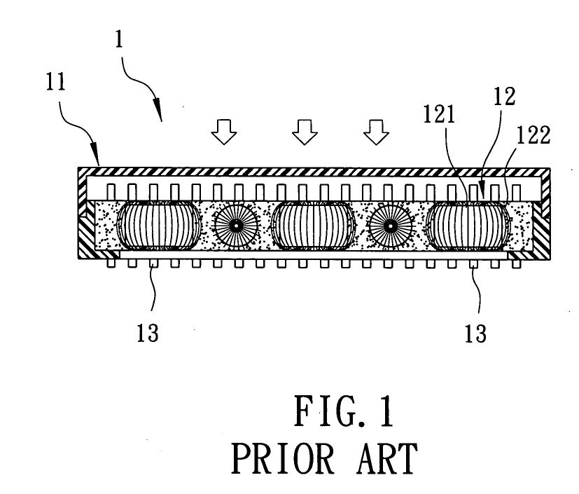

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

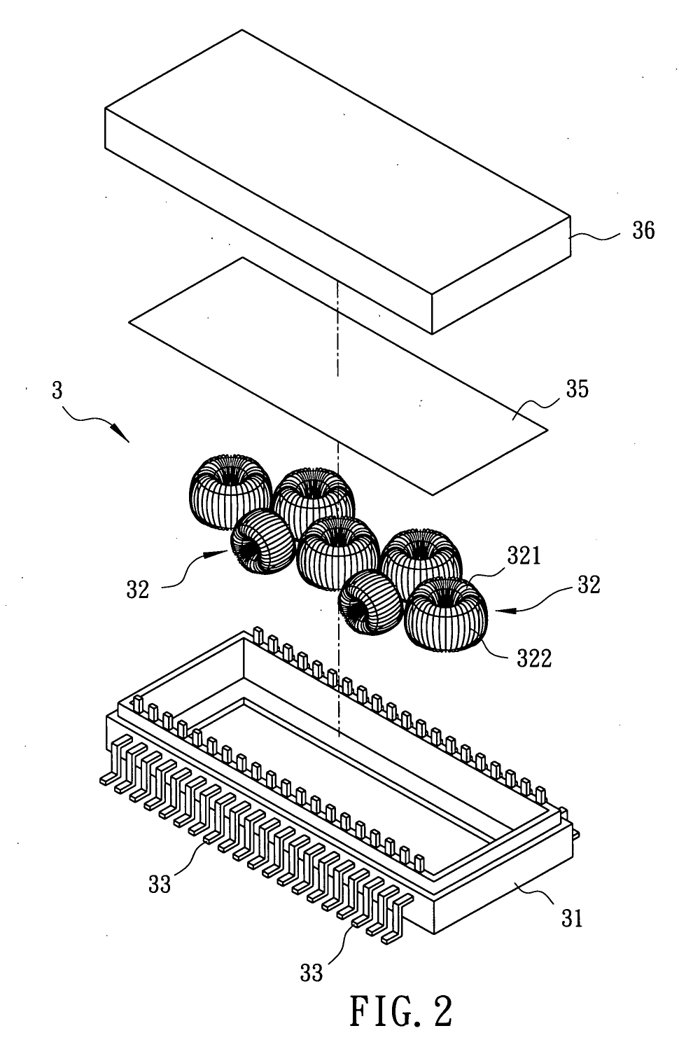

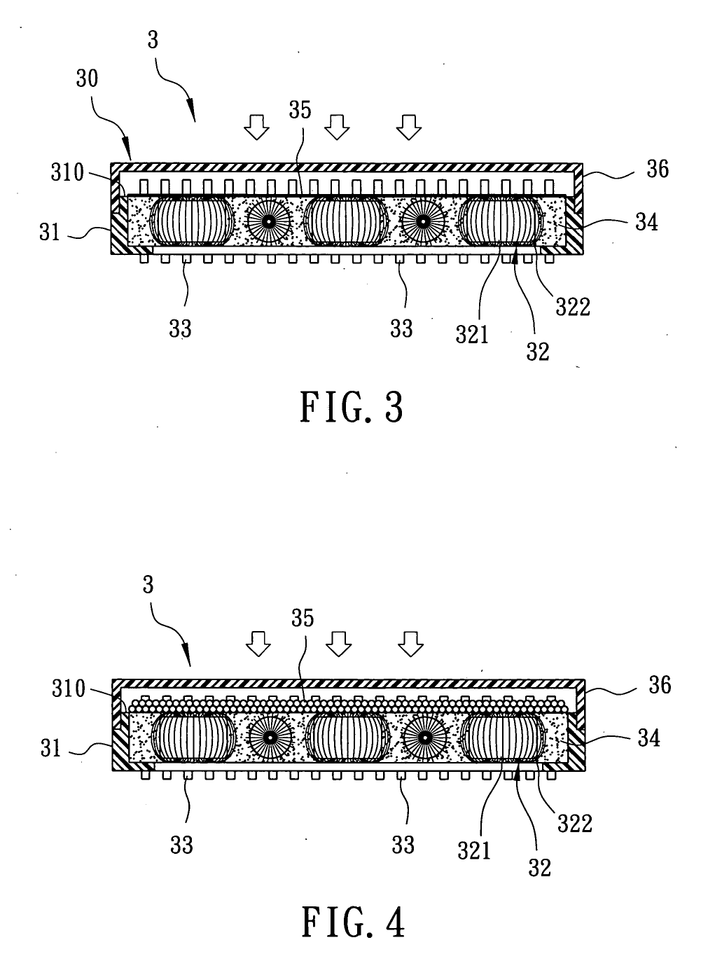

FIGS. 2 and 3 illustrate the first preferred embodiment of an electric device 3 of this invention. The electric device 3 includes: a housing 30; a plurality of conductive leads 33 provided on the housing 30; a plurality of coil units 32 disposed in the housing 30 and electrically connected to the conductive leads 33; and a heat insulator 35 disposed in the housing 30 and covering at least one side of the coil units 32. Each coil unit 32 includes a core 321 and an enamelled wire 322 wound around the core 321.

Preferably, the housing 30 includes a base part 31 confining an inner space 310, and a cover part 36 mounted on the base part 31.

Preferably, the electric device 3 further includes an encapsulant 34 made from an adhesive and filled in the inner space 310 so as to fix the coil units 32 and the heat insulator 35 in the housing 30.

In this embodiment, the heat insulator 35 is made from a polymer, ceramics, and the combination thereof. The heat insulator 35 includes an insulating sheet, and is disposed between the coil units 32 and the cover part 36 for blocking heat provided from a heating device (not shown) and flowing from an upper side of the cover part 36 in a direction indicated by the arrow symbols shown in FIG. 4. The heat insulator 35 is preferably a 1350 film tape® manufactured by 3M company.

FIG. 4 illustrates the second preferred embodiment of an electric device 3 according to this invention. The second preferred embodiment differs from the first preferred embodiment in that the heat insulator 35 includes a granular insulating material.

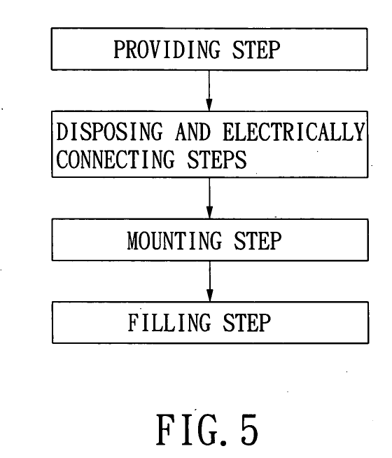

FIG. 5 illustrates consecutive steps of a method for producing the electric device 3 according to this invention. The method comprises the steps of: providing a housing 30 confining an inner space 310 therein and provided with a plurality of conductive leads 33 thereon; disposing a plurality of coil units 32 in the inner space 310 of the housing 30, and electrically connecting the coil units 32 to the conductive leads 33, each coil unit 32 having a core 321 and an enamelled wire 322 wound around the core 321; and mounting a heat insulator 35 in the inner space 310 of the housing 30 for covering one side of the coil units 32.

Preferably, the method further includes the step of filling the inner space 310 with an adhesive to form an encapsulant 34 encapsulating the coil units 32, followed by attaching the heat insulator 35 to the encapsulant 34 so as to cover said one side of the coil units 32.

It should be noted herein that the structure of the heat insulator 35 is not limited to the aforesaid embodiments. For example, the heat insulator 35 of this invention can include an insulating strip, an insulating block, a powdered insulating material, etc. Moreover, the arrangement of the heat insulator 35 is not limited to the disclosed embodiments, and can be varied based on the direction of the heat flow. For example, the heat insulator 35 can be disposed around the coil units 32 when the heat flow is provided around the electric device 3.

Tests in heat resistance of the electric device 3 of this invention and the conventional electric device 1 were conducted at a raising temperature from 200 to 270° C. by undergoing a reflowing process. The highest furnace temperature that can be tolerated by the conventional electric device 1 is below 225° C. The electric device 3 of this invention can be exposed to a temperature ranging from 225 to 270° C. for 70 seconds, and can be exposed to a temperature ranging from 260 to 270° C. for 25 seconds.

The samples of the conventional electric device 1 and the samples of the electric device 3 of this invention that underwent the reflowing process at 260 to 270° C. were subjected to a high voltage resistance (1.5 kilovolt) test. The failure percentage of the conventional electric devices 1 that were exposed to a temperature within 260 to 270° C. is 60 to 70%, whereas the failure percentage of the electric devices 3 of this invention is below 2%. It is evident that the electric device 3 of this invention can endure a high temperature of up to 270° C. while maintaining the required properties thereof.

According to the present invention, with the inclusion of the heat insulator 35 in the electric device 3 of this invention, heat damage to a coating on the enamelled wire 322 of each coil unit 32 can be alleviated.

While the present invention has been described in connection with what is considered the most practical and preferred embodiments, it is understood that this invention is not limited to the disclosed embodiments but is intended to cover various arrangements included within the spirit and scope of the broadest interpretation and equivalent arrangements.

What is claimed is:

1. An electric device comprising:
a housing;
a plurality of conductive leads provided on said housing;
at least one coil unit disposed in said housing, electrically connected to said conductive leads, and including a core and an enamelled wire wound around said core; and
a heat insulator disposed in said housing and covering at least one side of said coil unit.

2. The electric device of claim 1, wherein said housing includes a base part confining an inner space, and a cover part mounted on said base part.

3. The electric device of claim 2, further comprising an encapsulant filled in said inner space.

4. The electric device of claim 2, wherein said heat insulator is disposed between said cover part and said coil unit.

5. The electric device of claim 1, wherein said heat insulator is made from a material selected from the group consisting of a polymer, ceramics, and the combination thereof.

6. The electric device of claim 1, wherein said heat insulator includes an insulating sheet.

7. The electric device of claim 5, wherein said heat insulator includes a granular insulating material.

8. A method for producing an electric device comprising the steps of:
providing a housing confining an inner space therein and provided with a plurality of conductive leads thereon;
disposing at least one coil unit in the inner space of the housing, and electrically connecting the coil unit to the conductive leads, the coil unit having a core and an enamelled wire wound around the core; and
mounting a heat insulator in the inner space of the housing for covering one side of the coil unit.

9. The method of claim 8, further comprising filling the inner space with an adhesive to form an encapsulant encapsulating the coil unit, followed by attaching the heat insulator to the encapsulant so as to cover said one side of the coil unit.
